(19) United States
(12) Patent Application Publication
(10) Pub. No.: US 2016/0048484 A1
(43) Pub. Date: Feb. 18, 2016

(54) METHOD AND COMPUTER PROGRAM PRODUCT FOR CREATING AND MANAGING ONLINE CONTENT IN A WEBSITE OR WEB PLATFORM

(71) Applicant: Jose Fuillerat FLOR, Madrid (ES)

(72) Inventor: Jose Fuillerat FLOR, Madrid (ES)

(21) Appl. No.: 14/459,861

(22) Filed: Aug. 14, 2014

(51) Int. Cl. G06F 17/22; H04L 29/08

(52) U.S. Cl. CPC G06F 17/2247; H04L 67/02

(57) ABSTRACT

Method and computer program product for creating and managing online content in a web website or web platform

The method comprises creating at least one content module in a private user interface of an internal web page of the website or web platform, wherein said at least one content module is created after a correct logging of a user in said private interface by performing: a first step defining a size, shape and content of the content module; and a second step defining to which web page or pages of said website or web platform said defined content module should be inserted, and further providing a selectable functionality to the content module, said functionality including at least: connecting the content module to any internal web page, linking the content module to an external web page, and downloading a previous online uploaded web content on said content module, wherein once said at least one content module is created it is published in a public user interface.

### FIELD OF THE INVENTION

The present invention generally relates to the field of online content creation and web developing. In particular, the invention relates to a method and computer program product for creating and managing online content in web sites and/or web platforms.

In the invention a square or rectangular content module is the minimum unit which configures a visual user interface, based on a grid. Each content module can have different content and functionality and can be modified at any moment.

In addition, each website or web platform is divided in independent sections, referred as web pages that are created by a user (as many as the user wants). The created web pages are filed with the content modules (as many as desired). The website or web platform may be independent or be interconnected to form a network of platforms, termed here as an ecosystem.

For creating a content module, a private user interface with a logged access is needed. Once a content module exists it can be published an acceded on a public user interface but for any modification referred private user interface is needed. Preferably visual appearance of both user interfaces is identical.

### BACKGROUND OF THE INVENTION

The processes for creating, editing and managing web sites/platforms and web content have evolved over time. However, current systems require an excessively technical knowledge about its operation, making the development of these systems difficult to access and use by any user.

Other systems attempt to make the creation of the web sites/platforms more accessible but are nevertheless deficient in providing different modalities, without attending to the specific needs of the different types of web sites that exist on the Internet (corporate sites, online hard drives, online shops, etc.).

Apart from that, there are other systems whose limitations are found when it comes to simplify the creation and management of the web sites/platforms, since they create complicated CMS environments or backends with little graphics and nothing intuitive, causing that the user does not have an accurate view of what (s)he is creating, editing or managing once the task is complete.

Other systems offer the user the possibility of creating their web sites/platforms through templates, however these are inflexible and do not give the user freedom to create webs exactly as (s)he wants, but (s)he should adapt to default templates.

Other current systems are not adapted for viewing on technologies of new development (Eye devices, augmented reality) nor have flexible display modes without changing the design of the online contents.

Finally, other systems integrate in a separate way the different type of files (audio, video, text, images). However, they fail at making possible the integration of all these different type of files together in a unique similar way.

The problems with prior and existing processes for creating, editing and managing web sites/platforms and web content illustrate a need for a system that allows to create, manage and interconnect online content easily, fast, intuitively and in an interactive way.

### SUMMARY OF THE INVENTION

Embodiments of the present invention address these and/or other needs by providing a method for creating and managing online content in web sites or web platforms in a modular way, so that allowing combining large numbers of information in a minimum space and visualizing, at a glance, large networks of interconnected, and not fragmented, information.

In the embodiments of the invention, one or more content modules are created in a private user interface of an internal web page of the web sites or web platforms after a logging of the user in said private user interface. Once the content module has been created, the content module can be published in a public user interface of said internal web page of the website or web platform. Preferably both user interfaces, private and public, are visually identical.

The content module is created by performing: a first step that comprises defining a size, shape and content of the content module; and a second step that comprises defining in which web page (or web pages, as the content module can be inserted in more than one web page) of the website or web platform the content module defined in the first step should be inserted. Moreover, functionality to the content module is further provided including at least: connecting the content module to any internal web page of the website or web platform, linking the content module to an external web page of the website or web platform, and downloading a previous online uploaded web content on said content module.

In some embodiments of the method, the content of the created and published content module is further shared, from the public user interface, in a social network or in an email service provider.

Preferably, the provided functionality would be activated when pressing the content module, the content module being displayed on a screen of a computing device, such as a PC, a laptop, a PDA, a smartphone, a tablet, among any others, and the pressing being performed by directly touching the content module with a finger of a user or by clicking on the content module with a pointing device.

In some embodiments of the method, there are at least fourteen content modules, each of the content modules having a different content including at least one of a video, an image, a text, audio, a map, a calendar, a web-application, a social network, a hover, an article, an online shop or a slider.

The content module/s may be square and/or rectangular and may be ordered in the private user interface in priority order. Then, said priority order may be automatically reflected in the public user interface. The default order preferably is by creation date/time of the content module/s. However the order can also be assigned manually by a user using a computing device in the order the user wants.

In some embodiments of the method, the content module/s may include drag-and-move functionality.

In some embodiments of the method, the created website or web platform is supported over a cloud computing technology.

In accordance with embodiments of the invention, a computer program product comprising a computer readable medium having a computer-readable program code embodied thereon to create and manage online content in a website or web platform is also provided. The computer-readable program code comprises instructions that, when executed by one or more processors causes said one or more processors to create one or more content modules in a private user interface of an internal web page of the website or web platform by: the definition of a size, shape and content of the content module; and the definition to which web page or pages of said website or web platform the content module previously defined should be inserted, and the further provision of a functionality to said content module. The provided functionality can include: connecting the content module to the at least one internal web page of the website or web platform, linking the content module to an external web page of the website or web platform, and downloading a previous online uploaded web content on said one content module.

In some embodiments of the computer program product, the content module has a square or a rectangular shape which adjusts to a screen of a computing device.

In some embodiments of the computer program product, the content module comprises a drag-and-drop functionality allowing movement on a screen of a computing device.

Present invention is unique with respect to other known modular systems in the sense that aside, its ability to function as a manager and creator of online web sites and/or web platforms, also includes adjacent services such as online hard disks, mobile management applications' and an API for its development of applications in computing devices.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, in which:

FIG. 1 is an illustration of the proposed method for creating and managing online content in web sites or web platforms in accordance with some embodiments.

FIG. 2 is an illustration showing the overall operation of the invention, and how content modules create the web pages, how the web pages configure web platforms and how web platforms configure platform networks, i.e. ecosystems.

FIG. 3 is an example of the appearance of the public user interface and the private user interface presented in each internal web page of the website or web platform.

FIG. 4 is an illustration showing how the internal web page of the website or web platform is created and managed from the private user interface.

FIGS. 5a and 5b illustrate different alternatives of the appearance of the fractal arrangement provided by the present invention.

FIG. 6 illustrates different modes of view in which the invention can be visualized. FIG. 6a shows the Horizontal flow view mode, where the content modules are arranged in a row and are moving from left to right or vice versa through the screen of a computing device. FIG. 6b shows the Vertical flow view mode, where the content modules are arranged in a column and are moving up and down or vice versa. FIG. 6c shows the Organic view mode, where the content modules can be freely arranged in a tridimensional space.

FIG. 7 illustrates the responsive capacity of the invention.

FIG. 8 is an example showing how the different content modules can be arranged.

### DETAILED DESCRIPTION OF EMBODIMENTS OF THE INVENTION

While preferable embodiments of the invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

The invention provides an ecosystem of web sites and/or web platforms for the creation, editing, management and link, internally and/or externally to the web sites and/or web platforms, of online content. The invention allows users to interact with a series of content modules M that in total form an orthogonal grid forming a fractal system, and to auto-manage said content modules M in an easy, quick, graphic and interactive way.

The ecosystem has a login structure in which a user name and password has to be entered in order to securely protect personal information and to grant permissions for creating, editing, managing and linking a particular online site or platform. Depending on the login there exist different access levels:
Admin: This profile access level can create, edit and manage web pages, as well as create, edit, manage and interconnect content modules. The capacity of this access level is limited to the authorizations granted by a Super-admin profile. In this way, an admin profile is adjusted per web site and/or web platform. An admin can also authorize access to a user profile.
Super-admin: This profile access level has all the level options to create, manage, edit, and link all sites/platforms and with all the authorization levels. Only the super-admin profile has the necessary authorization level to authorize access to any other profiles (admin, user) and to introduce changes in the general visual appearance of the site/platform. For instance can change the color palette, typography, header logo, among others.
User. This Login option is present for sites/platforms with restricted access (in which an admin or super-admin authorize users) or for those sites/platforms in which its access is provided only for registered users. In this latter case, the site/platform has a register form (name, surname, email, password, and confirm password), as well as the option to start via a social network. A user profile cannot create, edit and manage the sites/platforms or the content modules, only interact with them.

According to the invention, a content module M, or Mtile as it will be referred from now, is the minimum unit that configures the visual interface, public (or FrontEnd) and private (or BackEnd). Each Mtile M is a module, having a square and/or a rectangular form, which can have different content and functionality. The size, shape, color, content and functionality of each Mtile M will be chosen and assigned by an administrator of the system (admin or super-admin).

The Mtiles M can be ordered in the orthogonal grid as the administrator wishes by dragging them from one side to the other. In the ecosystem exist at least fourteen different Mtiles M (M1 . . . M14), each one been specialized with a different content:
M1: Mtile Image: this module allows visualizing in high quality any kind of image or photograph, of any size and any format.
M2: Mtile video: this module allows uploading or linking videos to directly visualize them from the created online web site or web platform.
M3: Mtile Article: this module allows creating and arranging online contents as blog articles or blog entries.
M4: Mtile Text: this module allows writing and personalizing texts of different types, sizes, and colors.
M5: Mtile Fullpage: this module allows creating and personalizing online content (text, images, or both combined) directly viewable in full screen, i. e. completely filling a whole web page.
M6: Mtile Slider: this module allows converting text and images to online slides.
M7: Mtile Audio: this module allows uploading, recording, linking and reproducing any kind of music or sounds.
M8: Mtile Maps: this module allows introducing any world map, such as Google Maps®, and reflecting the world map in the web site or web platform.
M9: Mtile Hover: this module allows providing hover effects, i.e. defining a double-sided display, only visible when a mouse pointer passes over the module.
M10: Mtile Social Network: this module allows embedding in the form of an Mtile an online content already posted in a social network, or simultaneously posting in a social network a new online content directly from the web/platform.
M11: Mtile Shop: this module allows creating articles and assigning to said articles a price and connecting with a shopping cart functionality of with an online payment system.
M12: Mtile Calendar: this module allows introducing any kind of event (meetings, birthdays, notes, etc.) to an online calendar.
M13: Mtile App: this module allows embedding external functionalities or developed applications in the form of an Mtile.
M14: Mtile Slider Plus: this module allows creating online presentations, showing online presentations in full screen, controlling slideshow and using a virtual and interactive whiteboard.

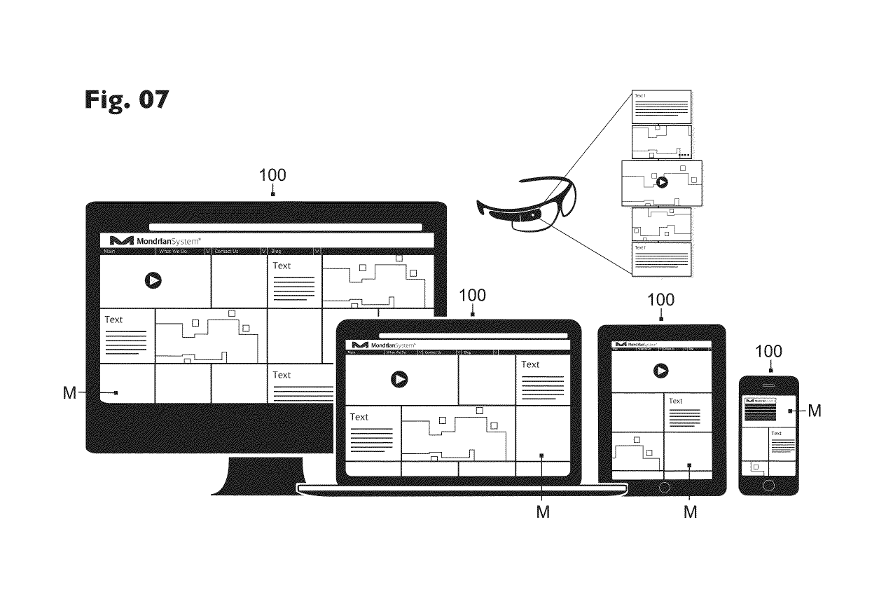

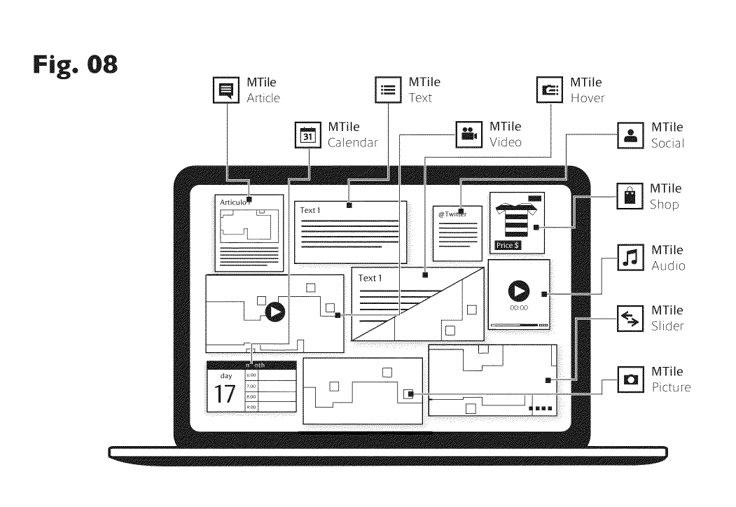

The ecosystem is supported over cloud computing technology, i.e. all its components are stored and running online, and has a fully graphical, interactive and intuitive interface that allows the user to control all aspects for creating and maintaining the created web site and/or web platform without the need of extensive programming knowledge. Moreover, the orthogonal grid has responsive capacity (as can be seen in FIG. 7), i.e. is able to adapt to different screen sizes of computing devices 100, and touch capacity as well as safety and privacy features based on a Login system. The responsive capacity is based on a responsive plugin termed (at the time of writing this specification) Masonry, a JavaScript grid layout library.

In addition, the invention also provides an application, or web API, for computing devices 100 such as Smartphones' or tablets that make easier the creation, editing, management, and linking of the online content in web sites and/or web platforms even without being connected to a communication network. Besides, the invention is optimized for different display modes being adaptable to new technologies such as Eye devices or augmented reality.

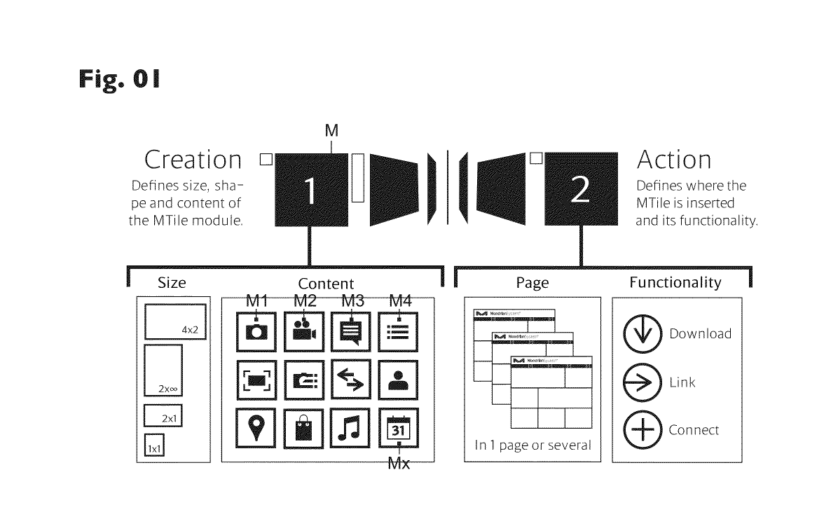

FIG. 1 shows the proposed method for creating and managing online content in a website or web platform. In the method, each Mtile M created in the private user interface of an internal web page of said website or web platform is created, managed and edited through emergent rotating windows in which the administrator only have to execute two processes: Creation 1 and Action 2. The first process, or step, defines a size, shape and content of the Mtile M (or Mtiles), whereas the second process defines in which web page or web pages of said website or web platform the previously defined Mtile M should be inserted.

When creating any MTile M, if desired in the Action step, functionality may also be given. The three main ones are:
Connect: allows choosing the internal web page of the website or web platform to which the created Mtile M will be connected.
Linking: allows introducing any kind of external link to which the created Mtile M will be connected.
Download: allows downloading or online displaying previous online uploaded web content on the created Mtile M.

Moreover, once the Mtile M (or Mtiles) is created it can be published in the public user interface from where the content of the Mtile M can be shared in a social network such as Facebook® or Twitter® or in an email service provider.

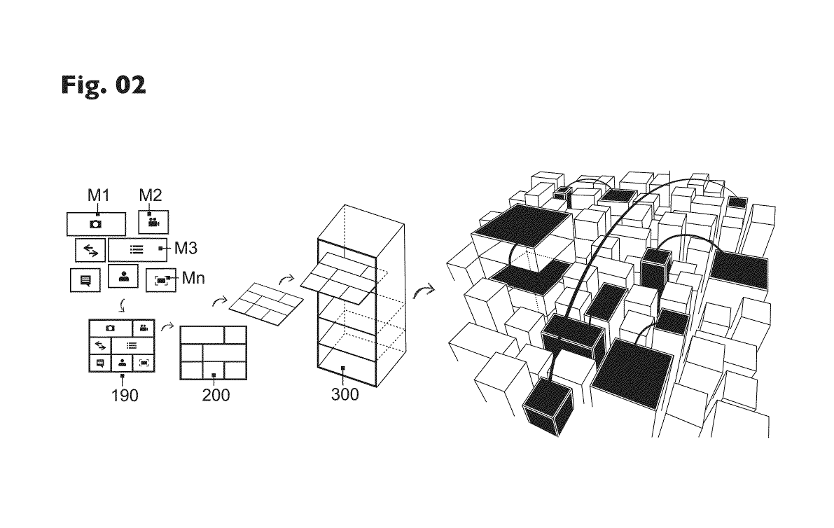

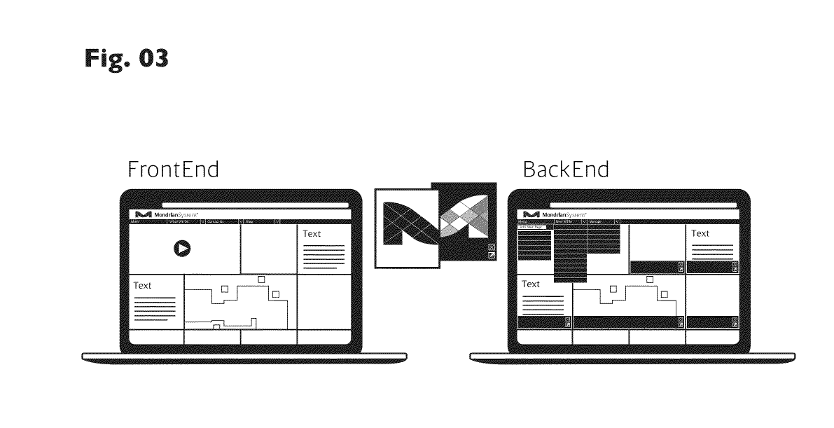

The Mtiles M, as showed in FIG. 2, are grouped in web pages to which is easily accessing from an upper menu of the public user interface (not illustrated in this figure). A set of web pages generates and organizes each web site or web platform. The public user interface, or FrontEnd, will permit visualizing all the Mtiles M and interact with them. The private user interface, or BackEnd, will permit create, managing and/or deleting web pages and Mtiles M. Preferably, as showed in FIG. 3, both interfaces are visually identical. This will help the administrator to always see the same information, that is to say “What you see is what you get”.

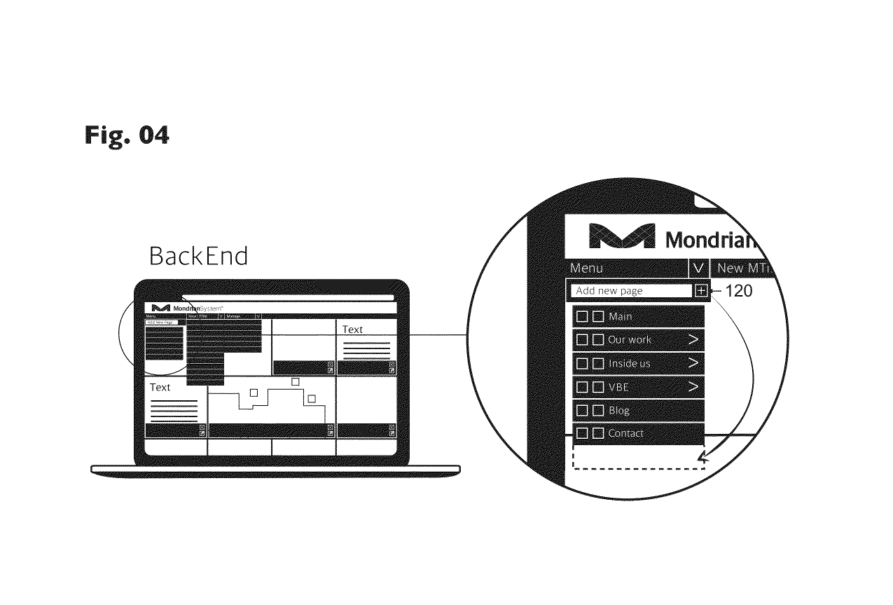

The creation of the internal web page of the website or web platform is a visual and intuitive process performed from a pop-up menu of the private user interface (FIG. 4) in two steps: first, a name is written and then + symbol 120 is pressed. Once the new internal web page is created as a tab in the menu the new internal web page can be moved to another web page to create subsections that will be visible as a pop-up menu in the upper menu bar of the public user interface.

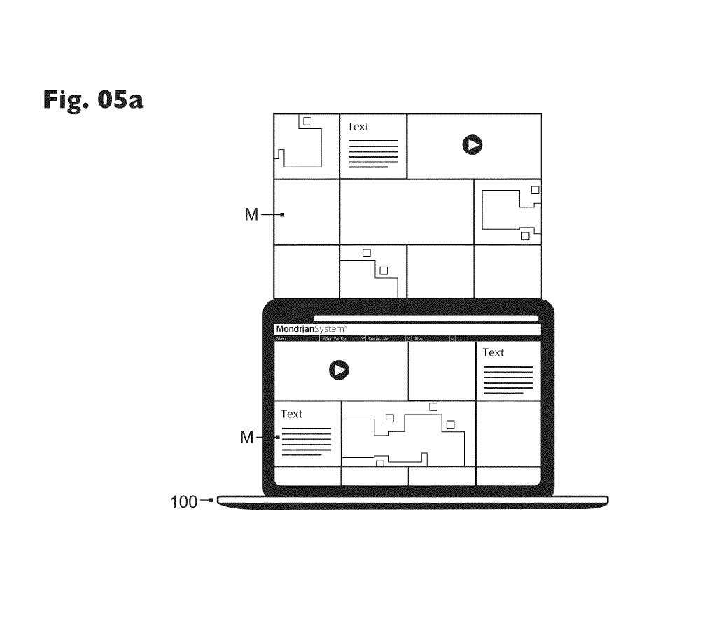

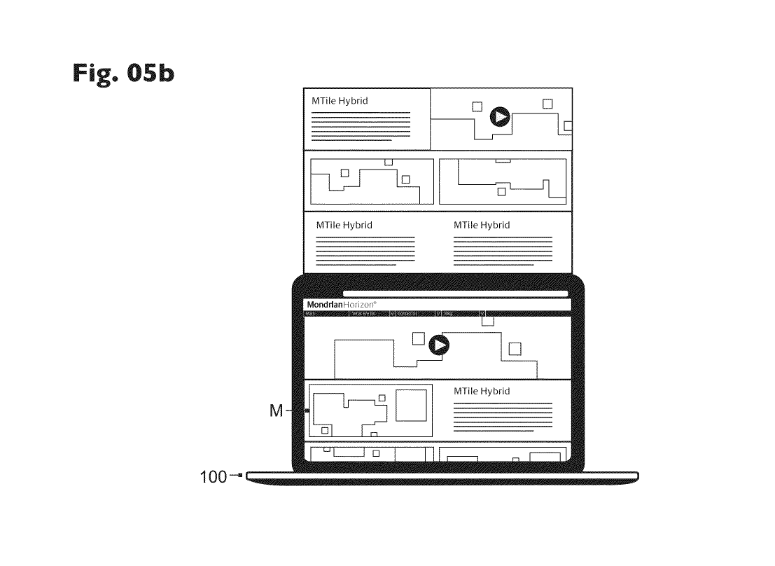

As an alternative or complement to the orthogonal grid (FIG. 5a), the invention, offers also a horizontal interface (FIG. 5b) where all the Mtiles M horizontally adjust to the entire screen of a computing device 100. This horizontal interface model incorporates a unique type of MTile M, a hybrid MTile, combining in a half of said unique Mtile M a particular content and in the other half another content. Said content could be text, image, video and slider. For instance, the unique Mtile M could be half image and half video, being all possible permutations possible between these contents. In addition, it is also possible repeating twice the same type of content (for example, image/image).

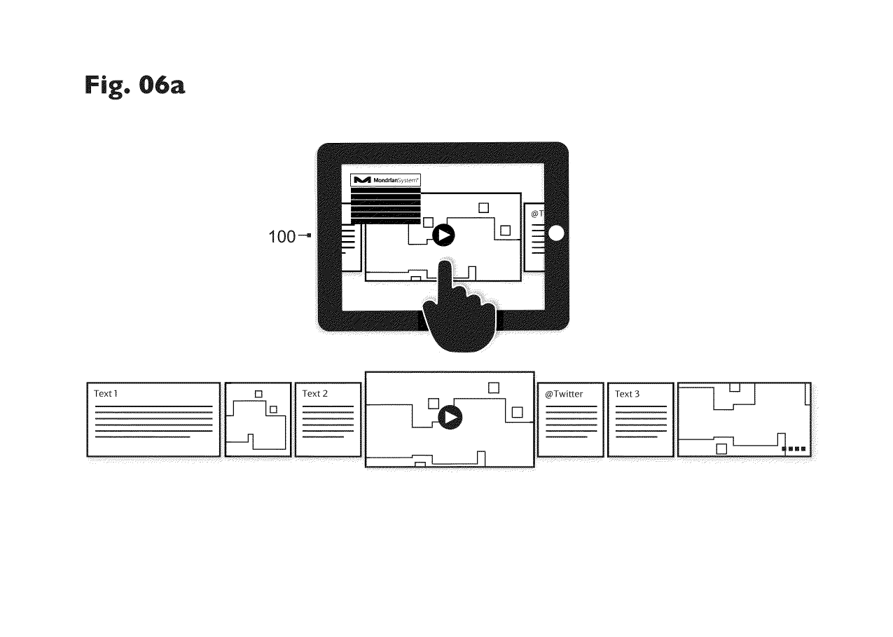

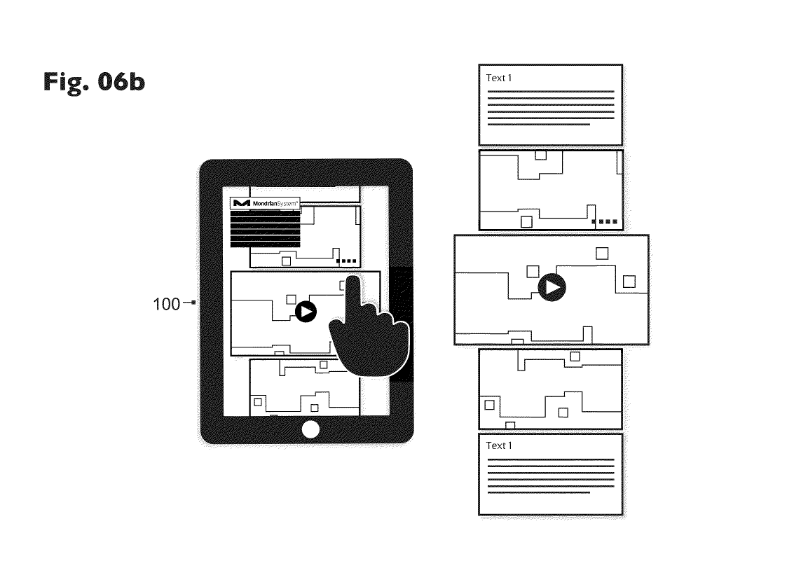

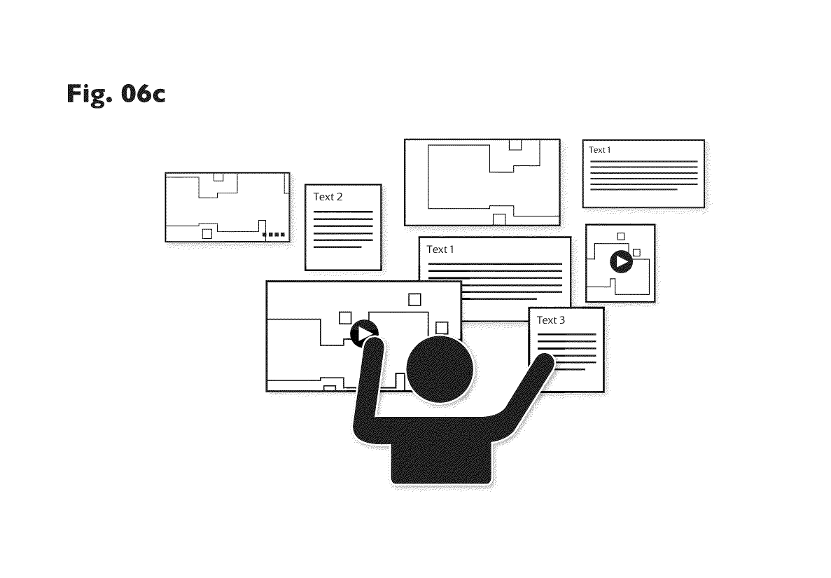

As previously described, the invention is optimized for different display modes being adaptable to new technologies such as Eye devices or augmented reality. FIGS. 6a, 6b and 6c illustrate some examples of these different view modes.

With respect to FIG. 6a it is illustrated an example of Horizontal flow view mode. This mode is developed for computing devices 100 such as tablets and Smartphones due its greater touch interaction capacity, but also it is optimized for its use in Eye devices. This view mode is switchable with the Vertical flow view mode. Thanks to the modular nature system, the Mtiles M can be arranged in a row and move from left to right or vice versa.

FIG. 6b illustrates an example of Vertical flow view mode that is similar to Horizontal flow view mode but in this case the Mtiles M are arranged in a column and move up and down or vice versa.

FIG. 6c illustrates an example of Organic view mode. In this view mode the Mtiles M can be freely arranged in a tridimensional space. This view mode is developed to work especially in Eye Devices along with augmented reality.

While the foregoing description has been with reference to particular embodiments of the present invention, it will be appreciated by those skilled in the art that changes to these embodiments may be made without departing from the principles and spirit of the invention. Accordingly, the scope of the present invention can only be ascertained with reference to the appended claims

1. A method for creating and managing online content in a website or web platform, the method comprising creating at least one content module in a private user interface of an internal web page of the website or web platform, wherein said at least one content module is created, after a logging of a user in said private user interface, by performing:
a first step comprising defining a size, shape and content of the at least one content module; and
a second step comprising defining in which web page or pages of said website or web platform said at least one content module defined in said first step should be inserted, and further providing a selectable functionality to said at least one content module, said functionality including:
connecting the at least one content module to any internal web page of the website or web platform,
linking the at least one content module to an external web page of the website or web platform, and
downloading a previous online uploaded web content on said at least one content module,
wherein once said at least one content module is created the content module is published in a public user interface of the internal web page of the website or web platform.

2. The method of claim 1, wherein the at least one content module comprises drag-and-move functionality allowing movement on a screen of a computing device.

3. The method of claim 1, wherein said selectable functionality further comprises disabling a previous link or removing the created at least one content module.

4. The method of claim 1, further comprising sharing, from said public user interface, the content of the at least one content module previously published in the public user interface in a social network or in an email service provider.

5. The method of claim 1, wherein the defined at least one content module comprises a square or a rectangular shape adjustable to a screen of a computing device either on full screen or as adjacent tiles, or a series of tiles in line either horizontally or vertically.

6. The method of claim 5, wherein the square or rectangular shape is arranged in different ways in said screen, including a fractal grid, a lineal row or organically in different 3D layers, optimized for their visualization in augmented reality.

7. The method of claim 1, comprising creating a plurality of content modules in the private user interface.

8. The method of claim 7, wherein the plurality of content modules comprises at least fourteen content modules, each of the content modules having a different content including at least one of a video, an image, a text, audio, a map, a calendar, a web-application, a social network, a hover, an article, an online shop or a slider.

9. The method of claim 7, wherein the plurality of content modules comprise a square and/or a rectangular form, so that providing fractal architecture to both the private and public user interface.

10. The method of claim 7, wherein the plurality of content modules are ordered in the private user interface in priority order.

11. The method of claim 10, wherein said priority order is assigned by a logged user using a computing device.

12. The method of claim 7, wherein the plurality of content modules include drag-and-move functionality.

13. The method of claim 7, further comprising sharing, from said public user interface, the content of at least some of the plurality of content modules previously published in the public user interface in a social network or in an email service provider.

14. The method of claim 1, wherein said selectable functionality being activated when pressing the at least one published content module, the content module being displayed on a screen of a computing device and the pressing being performed by directly touching the content module with at least a finger of a user or by clicking on the content module with a pointing device.

15. The method of claim 1, wherein the public user interface and the private user interface are visually identical.

16. The method of claim 1, wherein the website or web platform is supported over a cloud computing technology.

17. A computer program product comprising a computer readable medium having a computer-readable program code embodied thereon to create and manage online content in a website or web platform, the computer-readable program code comprising instructions that, when executed by one or more processors causes said one or more processors to create at least one content module in a private user interface of an internal web page of the website or web platform by:
the definition of a size, shape and content of the at least one content module; and
the definition to which web page or pages of said website or web platform the at least one content module previously defined should be inserted, and the further provision of a selectable functionality to said least one content module, said functionality including at least:
connecting the at least one content module to any internal web page of the website or web platform,
linking the at least one content module to an external web page of the website or web platform, and
downloading a previous online uploaded web content on said at least one content module,
wherein said created at least one content module is published in a public user interface of the internal web page of the website or web platform.

18. The computer program product of claim 17, wherein the at least one content module comprises a square or a rectangular shape which adjusts to a screen of a computing device either on full screen or as a tiles, or as a series of tiles in line either horizontally or vertically.

19. The computer program product of claim 17, wherein the at least one content module comprises a drag-and-drop functionality allowing movement on a screen of a computing device.
